(19) United States
(12) Patent Application Publication
(10) Pub. No.: US 2009/0237426 A1
(43) Pub. Date: Sep. 24, 2009

(54) LIQUID CONTAINER AND LIQUID CONSUMING APPARATUS

(75) Inventor: Hitotoshi KIMURA, Matsumoto-shi (JP)

Correspondence Address: SUGHRUE MION, PLLC, 2100 Pennsylvania Avenue, N.W., Washington, DC, 20037, US

(73) Assignee: SEIKO EPSON CORPORATION, Tokyo (JP)

(21) Appl. No.: 12/409,258

(22) Filed: Mar. 23, 2009

(30) Foreign Application Priority Data
Mar. 24, 2008 (JP) 2008-075582
Feb. 26, 2009 (JP) 2009-043433

(51) Int. Cl. B41J 2/195

(52) U.S. Cl. 347/7

(57) ABSTRACT

The liquid container includes a liquid storage portion that stores a liquid; a liquid feed portion that connects with the liquid consuming apparatus and feeds the liquid to the liquid consuming apparatus when the liquid container is attached to the liquid consuming apparatus, a liquid sensing chamber defining portion having a liquid inlet communicating with the liquid storage portion and a liquid outlet communicating with the liquid feed portion and that defines a liquid sensing chamber that fluctuates in volume according to a differential between atmospheric pressure received from an outside and pressure received from an inside, a bias force member that exerts a bias force on the liquid sensing chamber from an inner side in a direction of expansion of volume of the liquid sensing chamber, and a sensor that senses a decline in volume of the liquid sensing chamber to a prescribed volume value. A pressure of liquid present in the liquid sensing chamber declines as an amount of liquid in the liquid storage portion becomes lower. The bias force is established such that if the amount of liquid in the liquid storage portion is equal to or greater than a prescribed amount, the liquid sensing chamber overcomes atmospheric pressure to assume a volume exceeding a prescribed volume value, whereas if the amount of liquid in the liquid storage portion is less than a prescribed amount, the liquid sensing chamber yields to atmospheric pressure to assume a volume equal to or less than a prescribed volume value.

### CROSS REFERENCE TO RELATED APPLICATIONS

This application relates to and claims priority from Japanese Patent Application No. 2008-075582, filed on Mar. 24, 2008 and Japanese Patent Application No. 2009-43433, filed on Feb. 26, 2009, the entire disclosure of which is incorporated by reference.

### BACKGROUND

1. Technical Field

The present invention relates to a liquid container and to a liquid consuming apparatus.

2. Description of the Related Art

As one example of a conventional liquid container, the liquid container disclosed in Patent Citation 1 has a pressurization chamber (3) into which a pressurization fluid is introduced and pressurized; a liquid storage portion (7) adapted to be pressurized by the pressurization fluid and to expel liquid stored therein; and a liquid sensing device (11) used to sense the amount of stored liquid in the liquid storage portion (7). The liquid sensing device (11) is disposed inside the pressurization chamber (3), and has a liquid sensing chamber (21) having a liquid inlet (11a) that communicates with the liquid storage portion (7) and a liquid outlet (11b) that communicates with a liquid feed port (9) for feeding liquid to an external liquid consuming apparatus; a displaceable member (27) that is moveably actuated by the stored amount of liquid in the liquid storage portion (7); and sensing means adapted to sense the displacement of the displaceable member (27) to a prescribed location.

According to this liquid container, the frequency with which the internal capacity of the liquid sensing chamber experiences a large degree of deformation from maximum to minimum capacity will be once each time that the liquid in the liquid storage portion is exhausted. Consequently, in contrast to a receptacle having a liquid sensing device disposed to the outside of the pressurization chamber, the flexible walls of the liquid sensing chamber will not experience repeated frequent high levels of deformation, so materials of lower durability and cost can be used for the flexible walls of the liquid sensing chamber, thus contributing to lower cost through reduced cost of the flexible walls liquid sensing device used to sense the stored amount of liquid.

However, since this liquid container requires a pressurization chamber (3) into which the pressurization fluid is introduced and pressurized, pressurization fluid intake means, i.e. pressurization means, will be necessary.

Patent Citation 2 discloses an ink cartridge having a sensor chamber and an ink chamber, with a check valve disposed between the sensor chamber and a liquid intake. However, as this is also a pressurized system, pressurization means will be necessary.

Patent Citation 3 discloses an ink cartridge having a diaphragm pump (26) and an ink chamber (24), with a check valve (64) for the pump mechanism disposed between the diaphragm pump (26) and the ink chamber (24). However, in this design the ink cartridge is furnished with a diaphragm pump (26) adapted to operate numerous times, and since a diaphragm pump (26) adapted to operate numerous times must of necessity be more expensive owing to durability requirements, the cartridge will inevitably be more expensive as well.

Patent Citation 4 discloses an ink cartridge having a check valve disposed between an intake and an ink chamber. However, this ink cartridge lacks remaining liquid sensing means.

Patent Citation 1: Japanese Unexamined Patent Publication 2007-210330

Patent Citation 2: Japanese Unexamined Patent Publication 2004-351871

Patent Citation 3: Japanese Unexamined Patent Publication 09-164698

Patent Citation 4: Japanese Unexamined Patent Publication 2002-192739

### SUMMARY

It is accordingly one object of the present invention to provide a liquid container affording fewer parts and lower cost, despite being provided with means for sensing its own remaining amount of liquid. A further object is to provide a liquid consuming apparatus adapted to use this liquid container.

The liquid container according to a first mode of the present invention resides in a liquid container comprising: a liquid storage portion adapted to store a liquid for feeding to a liquid consuming apparatus unit and composed at least in part of a flexible member; a liquid feed port connected to the liquid consuming apparatus unit and adapted to feed liquid stored in the liquid storage portion to the liquid consuming apparatus unit; and a liquid sensing device adapted to sense remaining liquid amount inside the liquid storage portion; wherein the liquid sensing device includes: a liquid sensing chamber having a liquid inlet that communicates with the liquid storage portion and a liquid outlet that communicates with the liquid feed port; a flexible portion defining one face of the liquid sensing chamber and adapted to deform in response to the amount of liquid inside the liquid sensing chamber; a displaceable member housed within the liquid sensing chamber in manner permitting displacement thereof actuated by deformation of flexible portion; sensing means adapted to sense displacement of the displaceable member to a prescribed location; and an bias force member adapted to urge the displaceable member in a direction away from the prescribed location; and wherein the container satisfies the relationship Pf<Ps<Pe where Ps denotes pressure arising through biasing force biasing the displaceable member in a direction away from the prescribed location by the bias force member, Pf denotes the absolute value of negative pressure arising inside the liquid sensing chamber when liquid equal to or greater than a prescribed amount is present in the liquid storage portion; and Pe denotes the absolute value of negative pressure arising inside the liquid sensing chamber when the amount of liquid in the liquid storage portion is less than the prescribed amount.

According to this liquid container, because the magnitude of pressure Ps arising through biasing force by the bias force member lies within the range Pf<Ps<Pe, when liquid equal to or greater than a prescribed amount is present in the liquid storage portion, the pressure Ps arising through biasing force biasing the displaceable member in a direction away from the prescribed location by the bias force member will exceed the absolute value Pf of negative pressure arising inside the liquid sensing chamber as liquid is fed to the liquid consuming apparatus unit from the liquid feed port. Consequently, the displaceable member will move away from the prescribed location. Thus, the sensing means will be able to sense that liquid equal to or greater than a prescribed amount is present in the liquid storage portion.

On the other hand, as the amount of liquid in the liquid storage portion goes below the prescribed amount in association with feed of liquid from the liquid feed port, the pressure Ps arising through biasing force biasing the displaceable member in a direction away from the prescribed location by the bias force member will fall below the absolute value Pe of negative pressure arising inside the liquid sensing chamber as liquid is fed to the liquid consuming apparatus unit from the liquid feed port. Consequently, the displaceable member will move to the prescribed location. Thus, the sensing means will be able to sense that the amount of liquid in the liquid storage portion has fallen to less than the prescribed amount.

In another possible arrangement, displacement of the displaceable member will occur one time before the liquid in the liquid storage portion is exhausted. Moreover, there is no need for pressurizing means for pressurizing the perimeter of the liquid storage portion to bring about displacement of the displaceable member. That is, according to this liquid container, liquid can be supplied to the liquid consuming apparatus unit through a head differential or suction force on the liquid consuming apparatus unit side, thus making possible cost reductions while still providing remaining liquid sensing means.

The liquid container according to a second mode of the present invention resides in a liquid container comprising: a liquid storage portion adapted to store a liquid for feeding to a liquid consuming apparatus unit and composed at least in part of a flexible member; a liquid feed port connected to the liquid consuming apparatus unit and adapted to feed liquid stored in the liquid storage portion to the liquid consuming apparatus unit; and a liquid sensing device adapted to sense the remaining amount of liquid inside the liquid storage portion; wherein the liquid sensing device includes: a liquid sensing chamber having a liquid inlet that communicates with the liquid storage portion and a liquid outlet that communicates with the liquid feed port; a flexible portion defining one face of the liquid sensing chamber and adapted to deform in response to the amount of liquid inside the liquid sensing chamber; a displaceable member housed within the liquid sensing chamber and capable of displacement actuated by deformation of flexible portion; sensing means adapted to sense displacement of the displaceable member to a prescribed location; and an bias force member adapted to urge the displaceable member in a direction away from the prescribed location; and wherein a check valve adapted to block backflow of liquid from the liquid feed port towards the liquid sensing chamber is disposed between the liquid feed port and the liquid outlet from the liquid sensing chamber.

In the liquid container of the second mode of the present invention as well, when liquid equal to or greater than a prescribed amount is present in the liquid storage portion, the displaceable member will undergo displacement away from the prescribed location by the bias force member; and when the amount of liquid falls to less than the prescribed amount, the displaceable member will undergo displacement to the prescribed location in opposition to the biasing force of the bias force member. Thus, the sensing means will be able to sense that the amount of liquid in the liquid storage portion has fallen to less than the prescribed amount.

In particular, according to the second mode of the present invention, a check valve for blocking backflow of liquid from the liquid feed port towards the liquid sensing chamber is disposed between the liquid feed port and the liquid outlet from the liquid sensing chamber. Thus, if for some reason, such as entrainment through a liquid ejection nozzle of the liquid consuming apparatus unit, an air bubble should become entrained into the liquid flow channel on the downstream side from the liquid intake portion of the liquid consuming apparatus (the upstream side in relation to the direction of liquid feed), the bubble will be prevented from infiltrating the liquid sensing chamber. Since the bubble is prevented from infiltrating the liquid sensing chamber, sensor error will not occur.

The risk of such backflow will be greater in a pressurized system in which liquid is delivered by pressurizing the perimeter of the liquid storage portion, than it is in a non-pressurized system in which liquid is delivered through suction or a head differential, for example. The reason is that in a pressurized system, biasing force of the bias force member will act in a direction so as to push out backflow, whereas in a non-pressurized system biasing force of the bias force member will act in a direction so as to draw in backflow.

In another possible construction according to the first mode or second mode, the bias force member is composed of a spring interposed between the displaceable member and the liquid sensing chamber, between a first face of the liquid sensing chamber and the face opposing the first face; and the displaceable member and the first face of the liquid sensing chamber are disposed in abutment without being attached. With this arrangement, since there is no need for the displaceable member and the first face of the liquid sensing chamber to be attached, the first face of the liquid sensing chamber will not experience unwanted stress.

The liquid consuming apparatus according to a third mode of the present invention comprises a liquid intake portion connected to the liquid feed port of the liquid container having the check valve; a liquid consuming portion; and a diaphragm pump disposed between the liquid intake portion and the liquid consuming portion for the purpose of feeding liquid from the liquid intake portion to the liquid consuming portion and adapted to deliver liquid through application of external force in the direction of expansion of volume thereof from a previous state of having been urged in the direction of reduced volume followed by subsequent release of the external force; wherein pressure acting on the liquid sensing chamber resulting from external force applied in the direction of expansion of volume of the diaphragm pump will be greater than pressure applied to the liquid sensing chamber resulting from biasing force of the bias force member which urges the flexible portion of the liquid sensing chamber.

According to this liquid consuming apparatus, because the liquid container has a check valve, liquid can be supplied to the liquid consuming portion by the diaphragm pump, without necessarily having to provide a check valve between the liquid intake portion and the diaphragm pump. The cost of the liquid consuming apparatus can be reduced thereby.

Furthermore, according to this liquid consuming apparatus, when external force is applied in the direction of expansion of volume of the diaphragm pump, the decompression level acting on the liquid sensing chamber will exceed the pressure resulting from biasing force of the liquid sensing chamber. If there is sufficient liquid present in the liquid storage portion when the external force is applied, the liquid sensing chamber will experience substantially no change in volume, whereas if the level of liquid in the liquid storage portion is so low that liquid cannot be supplied to the liquid sensing chamber the absolute value of negative pressure of the liquid sensing chamber will exceed the pressure by the biasing force, so the volume will contract. Consequently, owing to the above pressure relationships, it will be possible to utilize volume changes of the liquid sensing chamber to sense the remaining amount of liquid.

The liquid consuming apparatus according to a fourth mode of the present invention comprises a liquid consuming apparatus unit and a liquid container attached to the liquid consuming apparatus unit; wherein the liquid container includes a liquid storage portion adapted to store a liquid for feeding to the liquid consuming apparatus unit and composed at least in part of a flexible member, a liquid feed port connected to the liquid consuming apparatus unit and adapted to feed liquid stored in the liquid storage portion to the liquid consuming apparatus unit, and a liquid sensing device adapted to sense the remaining amount of liquid inside the liquid storage portion; the liquid sensing device includes a liquid sensing chamber having a liquid inlet that communicates with the liquid storage portion and a liquid outlet that communicates with the liquid feed port, a flexible portion defining one face of the liquid sensing chamber and adapted to deform in response to the amount of liquid inside the liquid sensing chamber, a displaceable member housed within the liquid sensing chamber and capable of displacement actuated by deformation of flexible portion, sensing means adapted to sense displacement of the displaceable member to a prescribed location, and an bias force member adapted to urge the flexible portion in the direction of expansion of volume of the liquid sensing chamber; the liquid consuming apparatus unit includes a liquid intake portion connected to the liquid feed port of the liquid container, a liquid consuming portion, a diaphragm pump disposed between the liquid intake portion and the liquid consuming portion for the purpose of feeding liquid from the liquid intake portion to the liquid consuming portion and adapted to deliver liquid through application of external force in the direction of expansion of volume thereof from a previous state of having been urged in the direction of reduced volume followed by subsequent release of the external force, and a check valve disposed between the diaphragm pump and the liquid intake portion and adapted to block backflow of liquid from the diaphragm pump towards the liquid intake portion; and wherein pressure acting on the liquid sensing chamber resulting from external force applied in the direction of expansion of volume of the diaphragm pump will be greater than pressure applied to the liquid sensing chamber resulting from biasing force of the bias force member.

According to this liquid consuming apparatus, when external force is applied in the direction of expansion of volume of the diaphragm pump, if sufficient liquid is present in the liquid storage portion, the volume of the liquid sensing chamber will remain substantially unchanged; whereas if the level of liquid in the liquid storage portion is so low that liquid cannot be supplied to the liquid sensing chamber the absolute value of negative pressure inside the liquid sensing chamber will exceed the pressure by the bias force member, so the volume of the liquid sensing chamber will contract. Consequently, owing to the above pressure relationships, it will be possible to utilize volume changes of the liquid sensing chamber to sense the remaining amount of liquid. Additionally, a check valve adapted to block backflow of liquid from the liquid feed port towards the liquid sensing chamber is disposed between the liquid feed port and the liquid outlet of the liquid sensing chamber. Thus, if for some reason, such as entrainment through a liquid ejection nozzle of the liquid consuming apparatus unit, an air bubble should become entrained into the liquid flow channel on the downstream side from the liquid intake portion of the liquid consuming apparatus (the upstream side in relation to the direction of liquid feed), the bubble will be prevented from infiltrating the liquid sensing chamber. Since bubbles are prevented from infiltrating the liquid sensing chamber, sensor error will not occur.

The liquid consuming apparatus according to a fifth mode of the present invention comprises a liquid consuming apparatus unit and a liquid container attached to the liquid consuming apparatus unit; wherein the liquid container includes a liquid storage portion adapted to store a liquid for feeding to the liquid consuming apparatus unit and composed at least in part of a flexible member, a liquid feed port connected to the liquid consuming apparatus unit and adapted to feed liquid stored in the liquid storage portion to the liquid consuming apparatus unit, and a liquid sensing device adapted to sense the remaining amount of liquid inside the liquid storage portion; the liquid sensing device includes a liquid sensing chamber having a liquid inlet that communicates with the liquid storage portion and a liquid outlet that communicates with the liquid feed port, a flexible portion defining one face of the liquid sensing chamber and adapted to deform in response to the amount of liquid inside the liquid sensing chamber, a displaceable member housed within the liquid sensing chamber and capable of displacement actuated by deformation of flexible portion, sensing means adapted to sense displacement of the displaceable member to a prescribed location, and an bias force member adapted to urge the flexible portion in the direction of expansion of volume of the liquid sensing chamber; the liquid container further includes a check valve disposed between the liquid feed port and the liquid outlet provided to the liquid sensing chamber and adapted to block backflow of liquid from the liquid feed port towards the liquid sensing chamber; the liquid consuming apparatus unit includes a liquid intake portion connected to the liquid feed port of the liquid container, a liquid consuming portion, and a diaphragm pump disposed between the liquid intake portion and the liquid consuming portion for the purpose of feeding liquid from the liquid intake portion to the liquid consuming portion and adapted to deliver liquid through application of external force in the direction of expansion of volume thereof from a previous state of having been urged in the direction of reduced volume followed by subsequent release of the external force; and wherein pressure acting on the liquid sensing chamber resulting from external force applied in the direction of expansion of volume of the diaphragm pump will be greater than pressure applied to the liquid sensing chamber resulting from biasing force of the bias force member.

According to this liquid consuming apparatus, when external force is applied in the direction of expansion of volume of the diaphragm pump, if sufficient liquid is present in the liquid storage portion the volume of the liquid sensing chamber will remain substantially unchanged; whereas if the level of liquid in the liquid storage portion is so low that liquid cannot be supplied to the liquid sensing chamber, the absolute value of negative pressure inside the liquid sensing chamber will exceed the pressure by bias force member and the volume of the liquid sensing chamber will contract. Consequently, owing to the above pressure relationships, it will be possible to utilize volume changes of the liquid sensing chamber to sense the remaining amount of liquid.

Moreover, because the liquid container has a check valve, liquid can be supplied to the liquid consuming portion by the diaphragm pump without necessarily having to provide a check valve between the liquid intake portion and the diaphragm pump. The cost of the liquid consuming apparatus can be reduced thereby.

In another possible arrangement of the liquid consuming apparatus according to the fifth mode of the present invention, an on-off valve is disposed on the liquid flow channel connecting the diaphragm pump and the liquid intake portion. With this arrangement, liquid can be prevented from dripping from the liquid intake portion when the liquid intake portion and the liquid feed port of the liquid container are disconnected.

The present invention in a sixth mode provides a liquid container attachable to a liquid consuming apparatus. The liquid container according to the sixth mode comprises a liquid storage portion that stores a liquid, a liquid feed portion that connects with the liquid consuming apparatus and feeds the liquid to the liquid consuming apparatus when the liquid container is attached to the liquid consuming apparatus, a liquid sensing chamber defining portion having a liquid inlet communicating with the liquid storage portion and a liquid outlet communicating with the liquid feed portion and that defines a liquid sensing chamber that fluctuates in volume according to a differential between external atmospheric pressure and internal pressure, a bias force member that exerts a bias force on the liquid sensing chamber from an inner side in a direction of expansion of volume of the liquid sensing chamber, and a sensor that senses if a volume of the liquid sensing chamber is reduced to a prescribed volume value. A pressure of liquid present in the liquid sensing chamber declines as an amount of liquid in the liquid storage portion becomes lower. The bias force is established such that if the amount of liquid in the liquid storage portion is equal to or greater than a prescribed amount, the liquid sensing chamber overcomes the atmospheric pressure to assume a volume exceeding the prescribed volume value, whereas if the amount of liquid in the liquid storage portion is less than the prescribed amount, the liquid sensing chamber yields to the atmospheric pressure to assume a volume equal to or less than the prescribed volume value. Since this arrangement does not require a pressurization device, the number of parts can be minimized, and reduced cost can be achieved.

In another possible arrangement of the liquid container according to the sixth mode, the liquid sensing chamber defining portion includes an open chamber portion having the liquid inlet, the liquid outlet, and an opening, and a flexible portion that is formed of flexible material capable of deformation in response to a differential between the atmospheric pressure and the internal pressure and that covers the opening to define the liquid sensing chamber in association with the open chamber portion. With this arrangement, a liquid sensing chamber adapted to undergo deformation in response to a differential between atmospheric pressure received from the outside and pressure received from the inside can be constituted in a simple manner.

Yet another possible arrangement of the liquid container according to the sixth mode further comprises a displaceable member housed within the liquid sensing chamber and capable of displacement due to deformation of the flexible portion. The sensor senses if volume of the liquid sensing chamber has dropped to the prescribed volume value by sensing if the displaceable member is displaced to a prescribed location. The bias force member biases the displaceable member in a direction away from the prescribed location. With this arrangement, drop in volume of the liquid sensing chamber to a prescribed volume can be sensed with a simple arrangement by sensing a prescribed location of the displaceable member.

In yet another possible arrangement of the liquid container according to the sixth mode, the bias force member is a spring disposed between the displaceable member and an opposing face situated in opposition to the flexible portion in the open chamber portion. The spring is not bonded to the opposing face and the displaceable member, but disposed in abutment with the opposing face and the displaceable member. With this arrangement, since there is no need for the displaceable member and the first face of the liquid sensing chamber to be attached, the first face of the liquid sensing chamber will not experience unwanted stress.

In yet another possible arrangement of the liquid container according to the sixth mode, the liquid storage portion is flexible at least in part, whereby the pressure of liquid present in the liquid sensing chamber declines as the amount of liquid in the liquid storage potion becomes lower. With this arrangement, depending on the rigidity of the flexible section of the liquid storage portion, the pressure of liquid present in the liquid sensing chamber will decline as the remaining amount of liquid in the liquid storage portion becomes progressively lower.

Yet another possible arrangement of the liquid container according to the sixth mode further comprises a check valve disposed between the liquid feed portion and the liquid outlet, and adapted to block backflow of the liquid from the liquid feed portion towards the liquid sensing chamber. With this arrangement, air bubbles entering from the liquid consuming apparatus for some reason can be prevented from infiltrating into the liquid sensing chamber. As a result, sensor error due to an air bubble infiltrating the sensor portion can be avoided.

In yet another possible arrangement of the liquid container according to the sixth mode, the bias force is established such that if the amount of liquid in the liquid storage portion is less than a prescribed value and the liquid is flowing from the liquid storage portion into the liquid consuming apparatus, the liquid sensing chamber yields to the atmospheric pressure to assume a volume equal to or less than the prescribed volume value. The sensing by the sensor is executed while the liquid is flowing in the liquid storage portion. When liquid is flowing through the liquid storage portion, pressure of the liquid in the liquid storage portion will be lower. Consequently, the liquid storage portion will reach a volume equal to less than a prescribed volume value only a single time before the amount of liquid of the liquid storage portion goes below a prescribed value. As a result, the number of times that the liquid storage portion changes in volume can be reduced, so the components that form the liquid storage portion can be less durable.

In yet another possible arrangement of the liquid container according to the sixth mode, the bias force is established such that if the amount of liquid in the liquid storage portion is less than a prescribed value, then regardless of whether there is flow of liquid in the liquid storage portion, the liquid sensing chamber yields to the atmospheric pressure to assume volume equal to or less than the prescribed volume value. The sensing by the sensor is executed while the liquid is not flowing in the liquid storage portion. With this arrangement, during periods that the liquid is not flowing in the liquid storage portion, it can be sensed whether the liquid storage portion has reached an amount of liquid equal to or less than a prescribed value.

The present invention in a seventh mode provides a liquid consuming system comprising a liquid consuming apparatus and a liquid container attachable to the liquid consuming apparatus. The liquid container includes a liquid storage portion that stores a liquid, a liquid feed portion that connects with the liquid consuming apparatus and feeds the liquid to the liquid consuming apparatus when the liquid container is attached to the liquid consuming apparatus, a liquid sensing chamber defining portion having a liquid inlet communicating with the liquid storage portion and a liquid outlet communicating with the liquid feed portion and that defines a liquid sensing chamber that fluctuates in volume according to a differential between atmospheric pressure received from an outside and pressure received from an inside, a bias force member that exerts a bias force on the liquid sensing chamber from an inner side in a direction of expansion of volume of the liquid sensing chamber, and a sensor that senses a decline in volume of the liquid sensing chamber to a prescribed volume value. A pressure of liquid present in the liquid sensing chamber declines as a amount of liquid in the liquid storage portion becomes lower. The bias force is established such that if the amount of liquid in the liquid storage portion is equal to or greater than a prescribed amount, the liquid sensing chamber overcomes atmospheric pressure to assume a volume exceeding a prescribed volume value, whereas if the amount of liquid in the liquid storage portion is less than a prescribed amount, the liquid sensing chamber yields to atmospheric pressure to assume a volume equal to or less than a prescribed volume value. The liquid consuming apparatus includes a liquid intake portion connected to the liquid feed portion of the liquid container, a liquid consuming portion, and a diaphragm pump disposed between the liquid intake portion and the liquid consuming portion and adapted to deliver the liquid to the liquid consuming portion via the liquid intake portion through application of external force in a direction of expansion of volume thereof from a previous state of having been urged in the direction of reduction of internal volume followed by subsequent release of the external force. Pressure acting on the liquid sensing chamber resulting from the external force is greater than pressure produced by the bias force of the bias force member. This arrangement affords working effects comparable to those of the liquid container according to the sixth mode. Furthermore, when external force is applied in the direction of expansion of volume of the diaphragm pump, the decompression level acting on the liquid sensing chamber will exceed the pressure by bias force member of the liquid sensing chamber. If there is sufficient liquid present in the liquid storage portion when external force is applied, the liquid sensing chamber will experience substantially no change in volume, whereas if the level of liquid in the liquid storage portion is so low that liquid cannot be supplied to the liquid sensing chamber the absolute value of negative pressure of the liquid sensing chamber will exceed the pressure by the biasing force, so the volume will contract. Consequently, owing to the above pressure relationships, it will be possible to utilize volume changes of the liquid sensing chamber to sense the remaining amount of liquid.

In another possible arrangement in the liquid consuming system according to the seventh mode, the liquid container further includes a check valve disposed between the liquid feed portion and the liquid outlet, and adapted to block backflow of the liquid from the liquid feed portion towards the liquid sensing chamber. With this arrangement, liquid can be supplied to the liquid consuming portion by the diaphragm pump without necessarily having to provide a check valve between the liquid intake portion and the diaphragm pump. The cost of the liquid consuming apparatus can be reduced thereby.

In yet another possible arrangement in the liquid consuming system according to the seventh mode, the liquid consuming apparatus further includes an on-off valve disposed between the diaphragm pump and the liquid intake portion. With this arrangement, liquid can be prevented from dripping from the liquid intake portion when the liquid intake portion and the liquid feed port of the liquid container are disconnected.

The above and other objects, characterizing features, aspects and advantages of the invention will be clear from the description of preferred embodiments presented below along with the attached drawings.

### BRIEF DESCRIPTION OF THE DRAWINGS

FIG. 1 is a construction drawing depicting an embodiment of a liquid container according to the present invention;

FIG. 2 is an illustration of operation when liquid inside a liquid container has been consumed;

FIG. 3 is a construction drawing depicting another embodiment of a liquid container according to the present invention;

FIG. 4 is an illustration of operation when liquid inside a liquid container has been consumed;

FIG. 5 is a schematic diagram depicting an embodiment of a liquid consuming apparatus according to the present invention;

FIG. 6 is a drawing illustrating operation of a liquid consuming apparatus;

FIG. 7 is a drawing illustrating operation of a liquid consuming apparatus;

FIG. 8 is a drawing illustrating operation of a liquid consuming apparatus; and

FIG. 9 is a drawing illustrating biasing force by an bias force member in a second embodiment.

### DETAILED DESCRIPTION OF THE PREFERRED EMBODIMENTS

The preferred embodiments of the present invention will now be described in detail. The embodiments set forth hereinbelow are not intended to unduly limit the particulars of the present invention recited in the appended claims; nor should all of the arrangements described in the embodiments be construed as essential means for solving the problems addressed by the present invention.

### A. First Embodiment

### (Liquid Container)

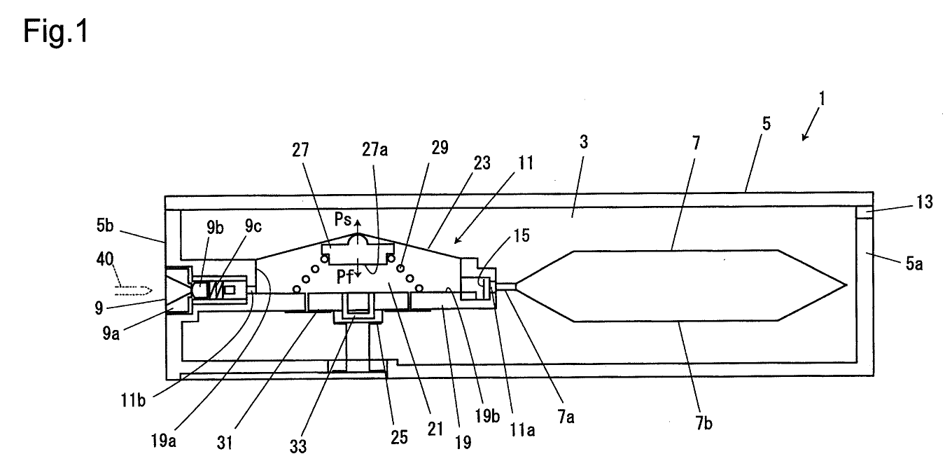

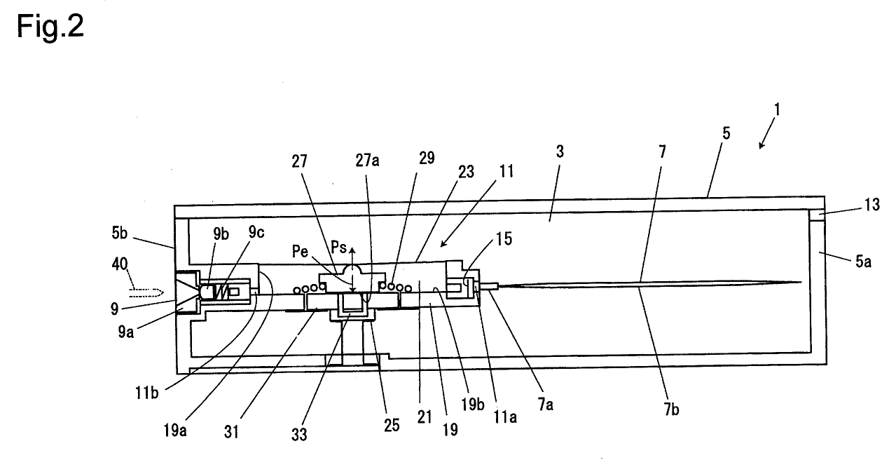

FIG. 1 is a construction drawing depicting an embodiment of a liquid container according to the present invention. FIG. 2 is an illustration of operation when liquid inside a liquid container 7 has been consumed.

The liquid container 1 of the present embodiment is an ink cartridge adapted for detachable installation in a cartridge installation portion of an inkjet recording device and designed to supply ink (liquid) to a liquid jetting head (liquid consuming portion) provided on the recording device.

This liquid container 1 is furnished with a liquid storage portion 7, a liquid feed port 9, and a liquid sensing device 11. The liquid storage portion 7 contains a liquid that is suctioned out and supplied to the liquid consuming apparatus unit, and is composed at least in part of a flexible member. The liquid feed port 9 is a feed port that is connected to the liquid consuming apparatus unit and that supplies the liquid consuming apparatus unit with the liquid contained in the liquid storage portion 7. The liquid sensing device 11, discussed later, is used to sense the remaining amount of liquid in the liquid storage portion 7.

The liquid sensing device 11 is furnished with a liquid sensing chamber 21, a flexible portion 23, a displaceable member 27, sensing means 25, and an bias force member 29. The liquid sensing chamber 21 has a liquid inlet 11a that communicates with the liquid storage portion 7, and a liquid outlet 11b that communicates with the liquid feed port 9. The flexible portion 23 defines one wall of the liquid sensing chamber 21 and is deformable according to the amount of liquid inside the liquid sensing chamber 21. The displaceable member 27 is housed within the liquid sensing chamber 21 so as to be capable of displacement actuated by deformation of flexible portion 23. The sensing means 25 can sense displacement of the displaceable member 27 to a prescribed location. The bias force member 29 urges the displaceable member 27 in a direction away from the prescribed location. Where Ps denotes pressure arising through biasing force biasing the displaceable member 27 in a direction away from the prescribed location (the direction indicated by arrow Ps) by the bias force member 29, Pf denotes the absolute value of negative pressure arising inside the liquid sensing chamber 21 through flow of liquid when liquid is delivered from the liquid feed port 9 to the liquid consuming apparatus unit when liquid equal to or greater than a prescribed amount is present in the liquid storage portion 7, and Pe denotes the absolute value of negative pressure arising inside the liquid sensing chamber 21 when liquid is delivered from the liquid feed port 9 to the liquid consuming apparatus unit when the amount of liquid in the liquid storage portion 7 is less than the prescribed amount (see FIG. 2), the biasing force Ps produced by the bias force member 29 will have magnitude within the range Pf<Ps<Pe.

The liquid container 1 has a case 5; the liquid storage portion 7 and the liquid sensing device 11 are housed inside this case 5. The case 5 is a housing of cube shape, and of the six confining walls that define an internal space 3, the confining wall 5a at a first end is perforated by an air vent hole 13. Where the case 5 has been formed by connecting a plurality of members, if the edges of the members are not sealed together, the interstices between the members will function analogously to the air vent hole 13, so the air vent hole 13 may not be needed in this case. Typically, it will be acceptable for the pressure of the space inside the case 5 to be equal to atmospheric pressure.

The liquid storage portion 7 is a so-called ink pack produced by joining a discharge spout 7a of tubular shape adapted to connect with the liquid inlet 11a of the liquid sensing device 11, to one end of a pouch 7b that has been constructed by bonding together the edges of aluminum laminate composite films composed of an aluminum layer laminated over a resin film layer. The use of aluminum laminate composite films ensures high gas barrier properties.

The liquid feed port 9 perforates the confining wall 5b at one end of the case 5. To the inside of the liquid feed port 9 there are provided an annular sealing member 9a for receiving insertion of a liquid feed needle 40 of the liquid consuming apparatus unit and pressing against the outside surface of the liquid feed needle 40 when the liquid container (cartridge) 1 is installed on the liquid consuming apparatus unit; a valve 9b adapted to abut the sealing member 9a and block off the liquid feed port 9 when the receptacle is not installed on the liquid consuming apparatus unit; and a compression spring 9c for biasing the valve 9b in a direction so as to press it against the sealing member 9a.

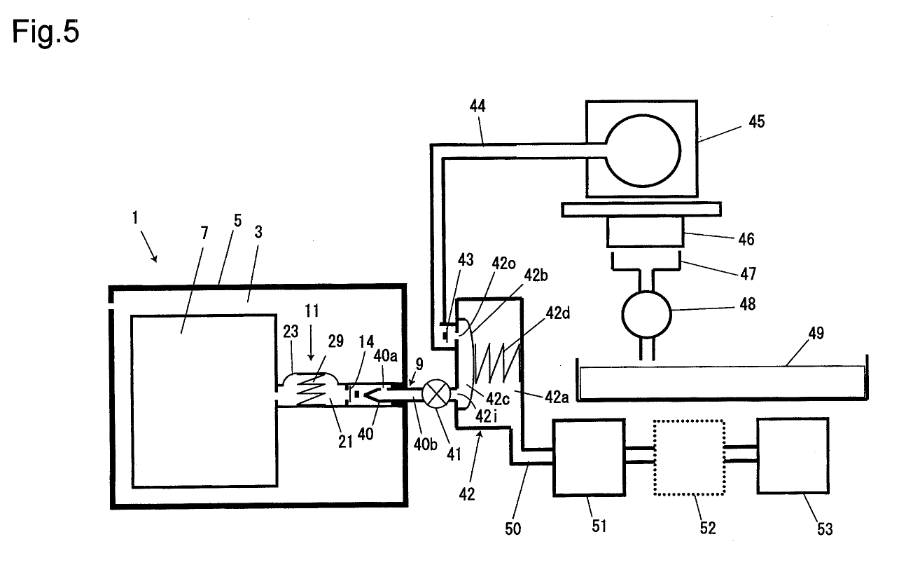

When the liquid container 1 is installed on the liquid consuming apparatus unit (see FIG. 5), the liquid feed needle 40 provided to the liquid consuming apparatus unit will insert into the liquid feed port 9, and the outside peripheral surface of the liquid feed needle 40 will seal liquidtightly against the inside peripheral surface of the sealing member 9a. The distal end of the liquid feed needle 40 will come into abutment against the valve 9b, pushing the valve 9b to the back and breaking the seal between the valve 9b and the sealing member 9a so that it will be possible for liquid to be fed into the liquid feed needle 40 from the liquid feed port 9.

The liquid sensing device 11 is furnished with a sensing device case 19, the flexible portion 23, an oscillation sensor 25, the displaceable member 27, and the bias force member 29. The sensing device case 19 has a recess space 19a connecting with the liquid inlet 11a that connects to the discharge spout 7a of the liquid storage portion 7 and with the liquid outlet 11b that connects to the liquid feed port 9. The flexible portion 23 is a confining wall that is made of flexible film and that seals off the opening at the top face of the recess space 19a to define the liquid sensing chamber (which also serves as a liquid holding chamber) 21. The oscillation sensor 25 is disposed at the bottom part of the recess space 19a where it is employed as the sensing means. The displaceable member 27 is mounted on the inside face of the flexible portion 23 and in opposition to the oscillation sensor 25. The bias force member 29 is compression-fit between this displaceable member 27 and the bottom of the recess space 19a so as to urge the displaceable member 27 and the flexible portion 23 in the direction of expansion of volume of the liquid sensing chamber 21. In the present embodiment, a torsion spring (compression spring) is employed as the bias force member 29.

The flexible portion 23 functions as a diaphragm for imparting displacement to the displaceable member 22 in response to pressure of liquid supplied to the liquid sensing chamber 21. The flexible portion 23 has ample flexibility enabling it to sense minute pressure fluctuations of the liquid so as to enhance sensor accuracy.

The bias force member 29 is composed of a compression spring of truncated conical shape. The compression spring employed as the bias force member 29 is disposed interposed between the flexible portion 23 which constitutes one face of the liquid sensing chamber, and the bottom face 19b of the sensing device case 19 which is the opposed face to this flexible portion face. The flexible portion 23 and the displaceable member 27 are disposed in abutment without being attached.

In the sensing device 19, the liquid inlet 11a has been integrally formed in one of the peripheral walls that define the recess space 19a, while the liquid outlet 11b that communicates with the liquid feed port 9 perforates the peripheral wall that faces this liquid inlet 11a. A check valve 15 is disposed in the liquid inlet 11a, and serves to block the flow of liquid attempting to backflow from the liquid sensing chamber 21 into the liquid storage portion 7.

As depicted in FIG. 2, the oscillation sensor 25 in the liquid sensing device 11 has a base plate 31 adapted to come into intimate contact against the displaceable member 27 when the liquid in the liquid storage portion 7 has been exhausted; a liquid conducting path 33 defined by a recess formed in the base plate 31; and a piezoelectric element adapted to apply oscillation to the liquid conducting path 33 and to sense free oscillation thereafter.

The oscillation sensor 25 detects whether liquid is present (i.e. the remaining amount of liquid) based on state changes (e.g. change in amplitude or frequency of residual oscillation) of free oscillation, which varies depending on whether the liquid conducting path 33 is closed off by the displaceable member 27.

When the liquid in the liquid storage portion 7 has been exhausted, the absolute value Pe of negative pressure arising inside the liquid sensing chamber 21 due to the liquid inside the liquid sensing chamber 212 having been supplied to the liquid consuming apparatus unit from the liquid feed port 9 will exceed the pressure Ps arising through biasing force by the bias force member 29, and thus the displaceable member 27 will be pushed downward in opposition to the bias force member 29 and come into intimate contact against the base plate 31.

As noted, the biasing direction of the bias force member 29 is also the direction of expansion of volume of the liquid sensing chamber 21, and is the opposite direction from the side where the oscillation sensor 25 is located. The liquid conducting path 33 which is formed by the recess in the base plate 31 will be defined within a closed space that with the displaceable member 27 in contact against the base plate 31 is sealed off from the liquid sensing chamber 21 as depicted in FIG. 2; and with the displaceable member 27 separated from the base plate 31 will communicate with the liquid sensing chamber 21 as depicted in FIG. 1.

In the present embodiment, the location at which the displaceable member 27 comes into contact against the base plate 31 due to a decreasing amount of liquid held in the liquid sensing chamber 21 corresponds to the prescribed location of the displaceable member in the claims. The point in time at which the displaceable member 27 comes into contact against the base plate 31 to render the liquid conducting path 33 a closed space will be set to a condition in which the level of liquid in the liquid storage portion 7 is less than the prescribed amount.

In the present embodiment, the liquid sensing device refers to a device that, by installing the liquid container on the liquid consuming apparatus unit, will connect with a sensor circuit or the like provided on the liquid consuming apparatus unit side and make up part of a liquid sensing system in order to be used to sense the amount of stored liquid.

### (Working Effects of Liquid Container 1)

According to the liquid container 1 described above, where Ps denotes pressure arising through biasing force biasing the displaceable member 27 in a direction away from the prescribed location by the bias force member 29, Pf denotes the absolute value of negative pressure arising inside the liquid sensing chamber 21 when liquid is delivered from the liquid feed port 9 to the liquid consuming apparatus unit when liquid equal to or greater than a prescribed amount (an amount sufficient for delivery to the liquid sensing chamber 21) is present in the liquid storage portion 7, and Pe denotes the absolute value of negative pressure arising inside the liquid sensing chamber 21 due to the flow of liquid being fed from the liquid feed port 9 to the liquid consuming apparatus unit when the amount of liquid in the liquid storage portion 7 is less than the prescribed amount, the pressure Ps produced by biasing force of the bias force member 29 will have magnitude within the range Pf<Ps<Pe. Thus, as depicted in FIG. 1, when liquid equal to or greater than a prescribed amount is present in the liquid storage portion 7, the pressure Ps arising through biasing force that urges the displaceable member 27 in a direction away from the prescribed location (in this embodiment, the location at which the displaceable member 27 comes into contact against the base plate 31) by the bias force member 29 will be greater than the absolute value Pf of negative pressure arising inside the liquid sensing chamber 21 due to the flow of liquid being fed from the liquid feed port 9 to the liquid consuming apparatus unit.

Consequently, the displaceable member 27 will undergo displacement away from the prescribed location. Thus, oscillation sensor 25 will sense that liquid is present in the liquid storage portion 7 in an amount equal to or greater than the prescribed amount.

While the pressure Ps produced by biasing force will vary depending on the location of the displaceable member 27, in the following discussion, it will be assumed to be Ps=+5 kPa for example. While in actual practice reaction force of the flexible portion constituting the diaphragm will come into play as well, this force will be ignored here. The following discussion shall take into consideration pressure Pp resulting from rigidity of the flexible film that defines the liquid storage portion 7, and the pressure drop Pr produced by fluid flow within the liquid storage portion 7, caused by the liquid sensing chamber 21 going to negative pressure.

When sufficient liquid is present in the liquid storage portion 7 as depicted in FIG. 1, pressure Pp resulting from rigidity of the flexible film that defines the liquid storage portion 7 will act so to push out liquid and increase pressure inside the liquid sensing chamber 21, bringing it to Pp=+0.5 kPa for example. In the absence of flow of liquid in FIG. 1, there will be no pressure drop Pr produced by fluid flow within the liquid storage portion 7. At this point, the sum of pressure inside the liquid sensing chamber 21 will be Ps+Pp=+5.5 kPa; pressure (Pp+Pr) excluding the pressure Ps produced by biasing force will be +0.5 kPa; and negative pressure will not arise (Ps>Pf (where Pf is the absolute value of negative pressure)). Thus, the displaceable member 27 will be pushed upward by the spring 29.

Next, when fluid flow occurs in FIG. 1, the pressure drop Pr produced by fluid flow within the liquid storage portion 7 will go to Pr=−0.5 kPa for example. At this point, the sum of pressure inside the liquid sensing chamber 21 will be Ps+Pp+Pr=+5.0 kPa; pressure (Pp+Pr) excluding the pressure Ps produced by biasing force will be −0.5 kPa; and the absolute value Pf (0.5 kPa) of negative pressure (−0.5 kPa) will be sufficiently lower than the biasing force (5.0 kPa) of the spring 29 (Ps>Pf). Thus, the displaceable member 27 will be pushed upward by the spring 29.

At this point, as depicted in FIG. 2 the flexible film of the liquid storage portion 7 (which is now substantially empty of liquid) will begin to dilate in reverse, and thus the pressure Pp resulting from rigidity of the flexible film that defines the liquid storage portion 7 will act so to suck back the liquid and bring the pressure inside the liquid sensing chamber 21 to negative pressure, for example to Pp=−3 kPa. If there is additional flow of liquid, the pressure drop Pr produced by fluid flow within the liquid storage portion 7 (whose flow channel has become constricted) will increase further, for example to Pp=−2.0 kPa. At this point, the sum of pressure inside the liquid sensing chamber 21 will be Ps+Pp+Pr=±0 kPa, which represents a state of equilibrium between the pressure Ps (=5 kPa) produced by biasing force of the bias force member 29 on the one hand, and other pressure (Pp+Pf) (=−5 kPa) on the other. That is, pressure (Pp+Pf) exclusive of biasing force Ps is −5 kPa; and the absolute value Pe (5 kPa) of negative pressure when the liquid is depleted is equal to the pressure Ps produced by biasing force of the bias force member 29 (Ps=Pe). This state represents the instant at which the displaceable member moves to the prescribed location; if the absolute value Pe of negative pressure is even slightly greater than this state (Ps<Pe), the displaceable member 29 will move to the prescribed location in opposition to the biasing force of the spring 29.

That is, as depicted in FIG. 2, when the amount of liquid in the liquid storage portion 7 falls below the predetermined amount in association with feed of liquid from the liquid feed port 9, the pressure Ps produced by biasing force biasing the displaceable member 27 in the direction away from the prescribed location by the bias force member 29 will be lower than the absolute value Pe of negative pressure arising in the liquid sensing chamber 21 when liquid is fed from the liquid feed port 9 to the liquid consuming apparatus unit.

Consequently, the displaceable member 27 will undergo displacement to the prescribed location. Thus, the oscillation sensor 25 will sense that the amount of liquid in the liquid storage portion 7 is now less than the prescribed amount. As will be appreciated from the above discussion, in first embodiment, sensing of the location of the displaceable member 27 by the oscillation sensor 25 takes place while the liquid is being fed from the liquid feed port 9 to the liquid consuming apparatus unit, i.e. while fluid is flowing inside the liquid sensing chamber 21 due to suctioning of the liquid feed port 9 by the liquid consuming apparatus.

Such displacement of the displaceable member 27 will take place one time before the liquid in the liquid storage portion 7 is exhausted. Additionally, there will be no need for pressurizing means in order to pressurize the perimeter of the liquid storage portion 7 in order to feed liquid from the liquid container 1. That is, according to this liquid container 1, liquid can be supplied through suction force on the liquid consuming apparatus side, thus obviating the need for pressurizing means and making possible lower cost, even where remaining liquid sensing means are provided.

Further, a check valve 15 is provided between the liquid sensing chamber 21 and the liquid storage portion 7. This check valve 15 will block the flow of liquid attempting to backflow into the liquid storage portion 7 from the liquid sensing chamber 21. The flexible film that defines the flexible portion 23 of the liquid sensing chamber 21 typically has lower gas barrier properties than does the multilayer flexible film that forms the liquid storage portion 7. Thus, liquid inside the liquid sensing chamber 21 (which has lower gas barrier properties) will be prevented from backflowing into the liquid storage portion 7 (which has excellent gas barrier properties), and thus air bubbles can be prevented from being entrained into the liquid storage portion 7.

Furthermore, as the bias force member 29, the bias force member 29 is provided interposed between a flexible portion constituting a first face of the liquid sensing chamber (i.e. the flexible portion 23) and a face opposing this flexible portion 23 (i.e. the base face 19b of the sensing device case 19), between the displaceable member 27 and the base face 19b. When doing this, the displaceable member 27 and the flexible portion 23 constituting the first face of the liquid sensing chamber may be simply disposed in abutment without being attached. This is because the displaceable member 27 will be normally maintained in contact with the flexible portion 23 by being pushed against it by the bias force member 29. Particularly where the bias force member 29 is a compression spring of truncated conical shape, displacement of the displaceable member 27 will be stabilized. Since the displaceable member 27 and the flexible portion 23 constituting the first face of the liquid sensing chamber 21 are not attached, the flexible portion 23 constituting the first face of the liquid sensing chamber 21 will not experience unwanted stress. However, the bias force member 29 is not limited to a compression spring of truncated conical shape, and the displaceable member 27 could instead be urged away from the prescribed location by a compression spring of tubular shape, a torsion coil spring, or the like.

### Other Embodiments

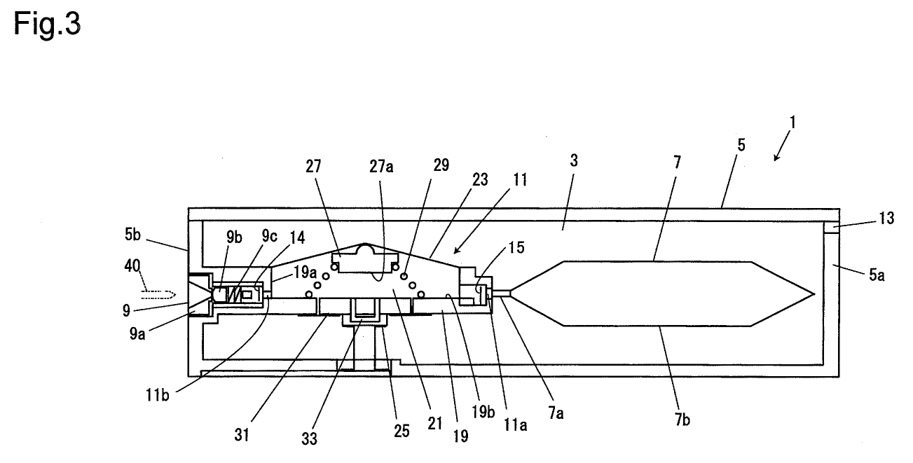

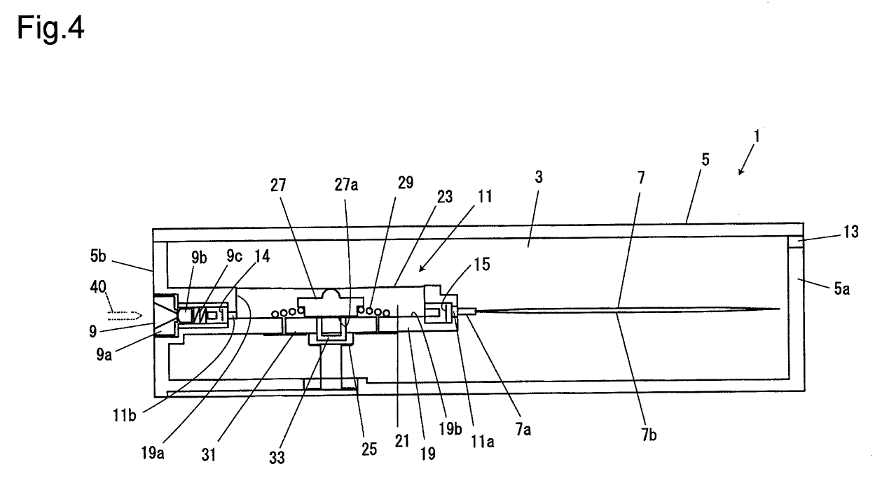

FIG. 3 is a construction drawing depicting another embodiment of a liquid container according to the present invention. FIG. 4 is an illustration of operation when the liquid inside the liquid container 7 has been consumed. In the drawings, parts identical or equivalent to those in the preceding embodiment are assigned like symbols.

This embodiment differs from the embodiment described previously in that a check valve 14 for blocking flow of liquid from the liquid feed port 9 to the liquid sensing chamber 21 is provided between the liquid feed port 9 and the liquid outlet 11b.

According to this liquid container, when liquid equal to or greater than a prescribed amount (an amount sufficient for delivery to the liquid sensing chamber 21) is present in the liquid storage portion 7, the displaceable member 27 will undergo displacement away from the prescribed location by the bias force member 29. The oscillation sensor 25 will therefore sense that liquid is present in the liquid storage portion 7 in an amount equal to or greater than the prescribed amount.

Meanwhile, the amount of liquid in the liquid storage portion 7 and in the liquid sensing chamber 21 will progressively decrease as the liquid is fed out from the liquid feed port 9. Once a given decrease is reached or exceeded, the displaceable member 27 will undergo displacement to the prescribed location. Thus, the oscillation sensor 25 will sense that the amount of liquid in the liquid storage portion 7 is less than the prescribed amount.

In the liquid container depicted in FIG. 3, the check valve 14 for blocking flow of liquid from the liquid feed port 9 to the liquid sensing chamber 21 is disposed between the liquid feed port 9 and the liquid outlet 11b from the liquid sensing chamber 21. Thus, if for some reason, such as entrainment through a liquid ejection nozzle of the liquid consuming apparatus unit, an air bubble should become entrained into the liquid flow channel on the downstream side from the feed needle 40 of the liquid consuming apparatus (the upstream side in relation to the direction of liquid feed), the bubble will be prevented from infiltrating the liquid sensing chamber 21.

If an air bubble should infiltrate the liquid sensing chamber 21, and if the air bubble should then infiltrate the liquid conducting path 33 used for sensing the presence of liquid, sensor error may result. According to this embodiment however, infiltration of air bubbles into the liquid sensing chamber 21 is prevented, so sensor error will not occur. This liquid container affords additional advantages deriving from its comparable design to the preceding embodiment.

The risk of backflow as described above will be greater in a pressurized system in which liquid is delivered by pressurizing the perimeter of the liquid storage portion, than it is in a non-pressurized system in which liquid is delivered through suction as in the present embodiment. The reason is that in a pressurized system, biasing force of the bias force member will act in a direction so as to push out backflow, whereas in a non-pressurized system biasing force of the bias force member 29 will act in a direction so as to draw in backflow.

### (Liquid Consuming Apparatus)

The liquid container 1 depicted in FIGS. 1 and 3 is designed such that the liquid feed needle 40 of the liquid consuming apparatus unit can connect to its liquid feed port 9 to feed the liquid inside the liquid container 1 to the liquid consuming portion (e.g. an inkjet head) on the basis of head difference or liquid suction action in the liquid consuming portion. The liquid feed needle 40 functions as a liquid intake portion for drawing liquid into the liquid consuming apparatus unit from the liquid container 1 via the liquid feed port 9. In this case, the contraction operation of the flexible portion 23 in the liquid container 1 will basically take place one time.

By providing the liquid consuming apparatus unit with a pump however, liquid feed to the liquid consuming portion can be stabilized further. An embodiment of a liquid consuming apparatus unit furnished with a pump will be described below.

FIG. 5 is a schematic diagram depicting an embodiment of a liquid consuming apparatus according to the present invention. This liquid consuming apparatus unit is equipped with a liquid feed needle 40 for connection to the liquid feed port 9 of the liquid container 1 having the check valve 14 shown in FIG. 3; and with a diaphragm pump 42 disposed between the liquid intake portion 40 and the liquid consuming portion 46, for delivering liquid from the liquid feed needle 40 to the liquid consuming portion (in this embodiment, a recording head) 46. The diaphragm pump 42 is designed to deliver liquid through application of external force in a direction expanding its volume from a previous state of having been urged in the direction of reduced internal volume, followed by subsequent release of this external force. The pressure acting on the liquid sensing chamber 21 as a result of this external force applied in a direction expanding the volume of the diaphragm pump 42 will be greater than the pressure applied to the liquid sensing chamber 21 by the biasing force of the bias force member 29 which urges the flexible portion 23 of the liquid sensing chamber 21.

The liquid consuming apparatus unit is additionally provided with a cap 47, a suction pump 48, and a waste ink absorber 49. The cap 47 is adapted to cover the nozzle face of the liquid consuming portion 46 when the liquid consuming portion 46 (recording head) is at the home position. The suction pump 48 is used to eliminate clogging by forcibly suctioning out ink from a nozzle through the cap 47 when a nozzle of the liquid consuming portion 46 has become clogged. The waste ink absorber 49 is used to absorb waste ink from the suction pump 48.

The liquid feed needle 40 is composed of a liquid feed needle (e.g. an ink feed needle) of known design adapted to insert into the liquid feed port 9. The liquid feed needle 40 has on its peripheral face an ink inlet hole 40a, and a liquid channel 40b communicating with this ink inlet hole 40a. The liquid consuming portion 46 is composed of an inkjet head of known design, for example.

The diaphragm pump 42 has a decompression chamber 42a; a diaphragm chamber 42c defined by a diaphragm 42b inside this decompression chamber 42a; and a compression spring 42d adapted to urge the diaphragm 42b in the direction of decreasing volume of the diaphragm chamber 42c. An air vent valve 51, an air passage pressure sensor 52, and a decompression pump 53 connect with the decompression chamber 42a through an air passage 50.

A liquid inlet 42i of the diaphragm chamber 42c connects to the liquid feed needle 40 via an on-off valve 41. A liquid outlet 42o of the diaphragm chamber 42c connects to the liquid consuming portion 46 via a check valve 43, a liquid feed passage 44, and a pressure regulating valve (self sealing valve) of known design. The pressure produced by the compression spring 42d which urges the diaphragm 42b of the diaphragm pump 42 will be a pressurizing force equal to or greater than the level necessary to feed liquid to the liquid consuming portion (recording head) 46 at a consistently sufficient feed.

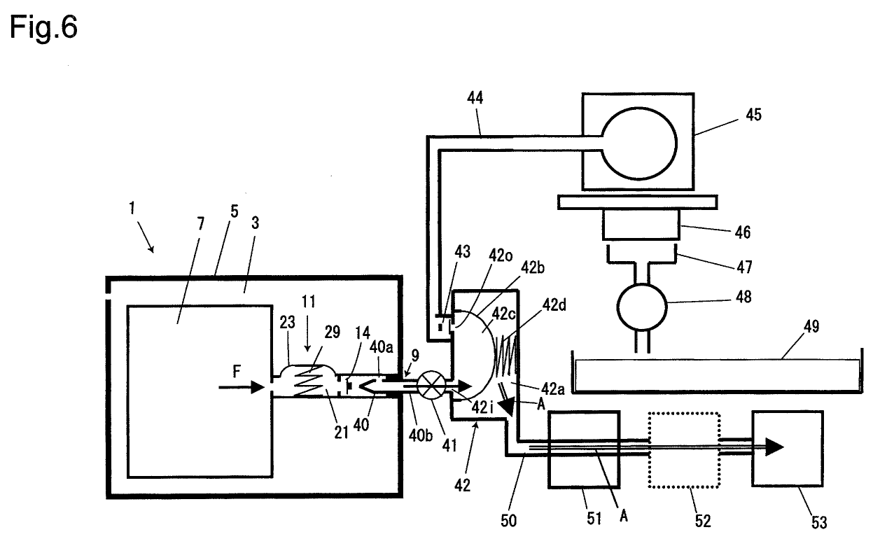

FIGS. 6 to 8 are drawings illustrating operation of the liquid consuming apparatus. The diaphragm pump 42 operates in the following manner.

(i) As depicted in FIG. 6, with the on-off valve 41 open, the decompression pump 53 is operated to draw out air (A) from the decompression chamber 42a as indicated by the arrow A and decompress the decompression chamber 42a, causing the diaphragm 42b to distend in opposition to the compression spring 42d, and liquid to be suctioned from the liquid storage portion 7 into the diaphragm chamber 42c as indicated by arrow F.

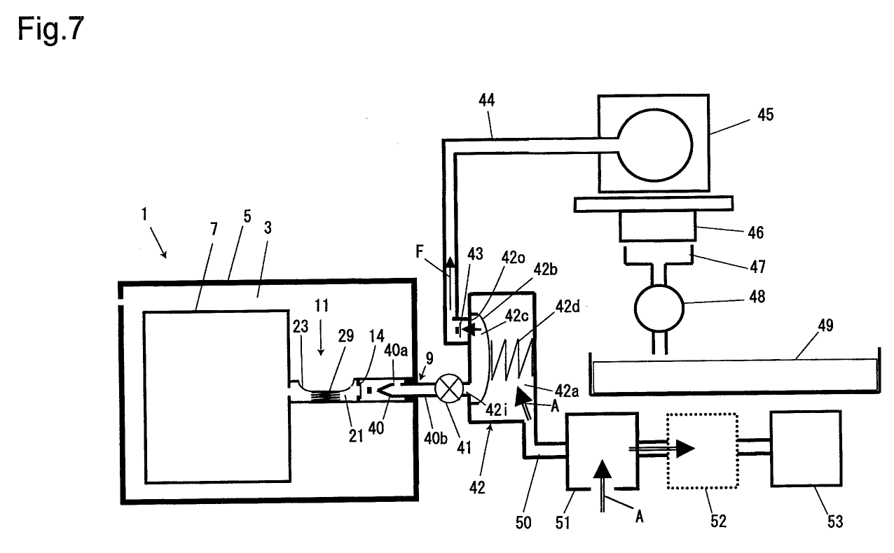

(ii) Subsequently, as depicted in FIG. 7, when the decompression pump 53 is stopped and the air vent valve 51 is opened, air (A) will inflow to the decompression chamber 42a as indicated by arrow A and the decompression chamber 42a will reach atmospheric pressure, and thus the diaphragm 42b will now be compressed by the spring 42d, the passage in the liquid feed passage 44 interior and leading up to the check valve 14 in the liquid container 1 interior will assume a pressurized state, and liquid will be fed appropriately to the liquid consuming portion 46.

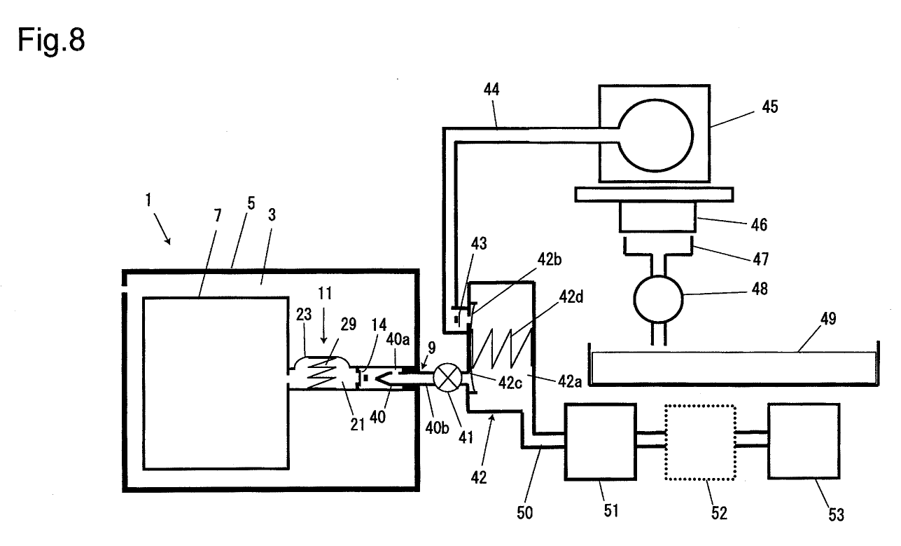

(iii) Subsequently, as depicted in FIG. 8, the liquid will be consumed by the liquid consuming portion 46, and at the point in time that no more liquid remains inside the diaphragm chamber 42c, the operations of (i) and (ii) above will repeat.

### (Working Effects of Liquid Consuming Apparatus)

According to this liquid consuming apparatus, because the liquid container 1 has a check valve 14, liquid can be supplied to the liquid consuming portion 46 by the diaphragm pump 42, without necessarily having to provide a check valve between the liquid feed needle 40 and the diaphragm pump 42 (the location of the on-off valve 41). The cost of the liquid consuming apparatus can be reduced thereby.

Furthermore, according to this liquid consuming apparatus, if the decompression level acting on the liquid sensing chamber 21 of the liquid container 1 (i.e. the pressure loss arising in the connecting passage between the liquid storage portion 7 and the liquid sensing chamber 21 due to the flow rate outflowing from the liquid storage portion 7 because of distension of the diaphragm pump through application of the external force) when external force is applied in the direction of expansion of volume of the diaphragm pump 42 as depicted in FIG. 6 has been set to a low level, if sufficient liquid is present in the liquid container 1, the liquid sensing chamber 21 will experience substantially no change in volume.

On the other hand, if the level of liquid in the liquid storage portion 7 is so low that liquid cannot be supplied to the liquid sensing chamber 21, when external force is applied in the direction of expansion of volume of the diaphragm pump 42, the volume of the liquid sensing chamber 21 will decrease (see FIG. 7). Consequently, owing to the above pressure relationships, it will be possible to utilize change in volume of the liquid sensing chamber 21 to sense the remaining amount of liquid.

Furthermore, according to this liquid consuming apparatus, because the liquid passage connecting the diaphragm pump 42 and the liquid feed needle 40 is provided with a on-off valve 41 capable of opening and closing irrespective of the flow of liquid, when the liquid feed needle 40 and the liquid feed port 9 of the liquid container 1 are disconnected, liquid can be prevented from dripping from the liquid feed needle 40 by shutting the on-off valve 41.

### (Variations of Liquid Consuming Apparatus)

While not illustrated in the drawings, in a liquid consuming apparatus according to another embodiment, a check valve can be provided between the diaphragm pump 42 and the liquid feed needle 40 to block the flow of liquid from the diaphragm pump 42 to the liquid feed needle 40 (while allowing flow in the opposite direction). The check valve can be disposed in series with the on-off valve 41, or provided in place of the on-off valve 41.

Such a liquid consuming apparatus will afford advantages comparable to the liquid consuming apparatus described previously. Additionally, because the device has a check valve provided between the diaphragm pump 42 and the liquid feed needle 40 to block the flow of liquid from the diaphragm pump 42 to the liquid feed needle 4, a liquid container that lacks a check valve 14 can be used.

### B. Second Embodiment

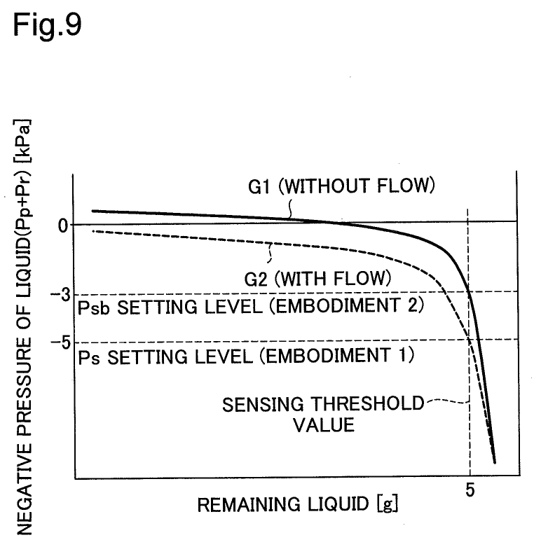

FIG. 9 is a drawing illustrating biasing force by an bias force member 29b in a second embodiment. This second embodiment differs from first embodiment in that sensing of the location of the displaceable member 27 by the oscillation sensor 25 takes place during periods in which liquid is not being fed from the liquid feed port 9 to the liquid consuming apparatus unit, that is, when the liquid consuming apparatus is not suctioning the liquid feed port 9, and liquid is not flowing through the liquid sensing chamber 21. Thus, the pressure Psb produced by biasing force of the bias force member 29b will be set to a different value from first embodiment.

FIG. 9 depicts a graph showing the relationship between the remaining amount of liquid in the liquid storage portion 7 and negative pressure inside the liquid sensing chamber 21. The vertical axis at left in FIG. 9 indicates negative pressure (Pb+Pr) arising inside the liquid sensing chamber 21. Graph G1 shows an instance in which there is no flow of liquid (ink) in the liquid sensing chamber 21 (i.e. where the flow rate is 0), whereas graph G2 shows an instance in which there is flow of liquid (ink) in the liquid sensing chamber 21 (i.e. where the flow rate is not 0). It will be appreciated that, as shown in FIG. 9, regardless of whether there is no flow of liquid (graph G1) or there is flow of liquid (graph G2), the absolute value of negative pressure inside the liquid sensing chamber 21 will be progressively greater the smaller the amount of liquid remaining in the liquid storage portion 7. That is, the pressure of liquid inside the liquid sensing chamber 21 will be progressively lower the smaller the amount of remaining liquid in the liquid storage portion 7, with respect to atmospheric pressure. From FIG. 9 it will be appreciated that the absolute value of negative pressure inside the liquid sensing chamber 21 in instances where there is flow of liquid in the liquid sensing chamber 21 (graph G2) is greater than the absolute value of negative pressure inside the liquid sensing chamber 21 in instances where there is no flow of liquid in the liquid sensing chamber 21 (graph G1). The reason is that where there is flow of liquid, a pressure drop Pr will arise due to the flow of liquid.

Here, as described in first embodiment, where there is flow of liquid in the liquid sensing chamber 21 (graph G2), negative pressure (differential pressure from atmospheric pressure) Pp+Pr inside the liquid sensing chamber 21 will reach −5.0 kPa when the remaining amount of ink in the liquid storage portion 7 has reached a prescribed value (in FIG. 9, 5 g). In first embodiment, the pressure Ps arising through biasing force by the bias force member 29 is set to Ps=+5.0 kPa. As a result, if the absolute value of the negative pressure Pp+Pr inside the liquid sensing chamber 21 goes above 5.0 kPa, the displaceable member 27 will assume a state in which it substantially abuts against the base plate 31 (a state of being at the prescribed location). As a result, during the time that there is flow of liquid in the liquid sensing chamber 21, i.e. during the time that the liquid feed port 9 is being suctioned by the liquid consuming apparatus, by sensing with the oscillation sensor 25 whether the displaceable member 27 is at the prescribed location, the liquid consuming apparatus will be able to sense whether the amount of remaining ink in the liquid storage portion 7 is equal to or less than the prescribed value.

On the other hand, where there is no flow of liquid in the liquid sensing chamber 21 (graph G1), negative pressure (differential pressure from atmospheric pressure) Pp inside the liquid sensing chamber 21 will reach −3.0 kPa when the remaining amount of ink in the liquid storage portion 7 has reached a prescribed value (in FIG. 9, 5 g). In second embodiment, the pressure Psb arising through biasing force by the bias force member 29 is set to Psb=+3.0 kPa. As a result, if the absolute value of the negative pressure Pp inside the liquid sensing chamber 21 goes above 3.0 kPa, the displaceable member 27 will assume a state in which it substantially abuts against the base plate 31 (a state of being at the prescribed location). As a result, at times of no flow of liquid in the liquid sensing chamber 21, i.e. at times that the liquid feed port 9 is not being suctioned by the liquid consuming apparatus, by sensing with the oscillation sensor 25 whether the displaceable member 27 is at the prescribed location, the liquid consuming apparatus will be able to sense whether the amount of remaining ink in the liquid storage portion 7 is equal to or less than the prescribed value.

For example, in the liquid consuming apparatus, if the circuit that supplies driving power to the piezoelectric element of the oscillation sensor 25 and the circuit that supplies driving power to the liquid consuming portion (recording head) 46 constitute a shared circuit, it will not be possible for the oscillation sensor 25 to be driven while the liquid consuming portion 46 is being driven. The liquid consuming apparatus suctions the liquid feed port 9 during driving of the liquid consuming portion 46, i.e. when liquid is being consumed. As a result, if the circuit that supplies driving power to the piezoelectric element of the oscillation sensor 25 and the circuit that supplies driving power to the liquid consuming portion (recording head) 46 constitute a shared circuit, there will be instances in which the liquid consuming apparatus cannot drive the oscillation sensor 25 during periods of flow of liquid in the liquid sensing chamber 21. According to second embodiment, at times of no flow of liquid in the liquid sensing chamber 21, i.e. when the liquid consuming apparatus is not driving the liquid consuming portion 46, it can drive the oscillation sensor 25 and sense whether the amount of remaining ink in the liquid storage portion 7 is equal to or less than the prescribed value. Consequently, in such a liquid consuming apparatus, the circuit that supplies driving power to the piezoelectric element of the oscillation sensor 25 and the circuit that supplies driving power to the liquid consuming portion (recording head) 46 can be a shared circuit. The number of parts of the liquid consuming apparatus can be reduced thereby, to achieve a more compact size.

Apart from the setting of the biasing force of the bias force member 29, the arrangement of second embodiment is comparable to first embodiment and will not be described in detail.

While preferred embodiments have been described in detail hereinabove, numerous modifications will be readily apparent to the practitioner of the art without substantially departing from the novelty and effects of the present invention. Accordingly, such modified examples will fall within the scope of the present invention. For example, terms that in at least one instance appear together with different terms of broader or identical meaning in the specification and drawings may be replaced with these different terms, at any point in the specification or drawings.

For example, the point in time at which the displaceable member 27 and the base plate 31 cooperate to define a sealed space in the liquid conducting path 33 can be set to a state in which the liquid in the liquid storage portion 7 has been substantially exhausted (near-end condition). By so doing, where employed as an ink cartridge for example, the piezoelectric sensing means of the liquid sensing device 11 can be effectively utilized as near-end sensing means adapted to sense a condition in which the amount of remaining ink in the liquid storage portion 7 is approaching zero.

The liquid container of the present invention is not limited to application in liquid cartridges for use in liquid jet recording devices. It may be adapted for use in liquid consuming apparatus of various kinds equipped with a liquid jetting head adapted to eject small amounts of a liquid in drop form. Herein, a drop refers to a state of a liquid as ejected from the liquid consuming apparatus, and includes granular, teardrop, or filiform shape with a tail.

Specific examples of liquid consuming apparatus include devices equipped with a coloring matter jetting head used to manufacture color filters for liquid crystal displays or the like; devices equipped with an electrode material (electrode paste) jetting head used to produce electrodes for organic EL displays, field emission displays (FED) or the like; devices equipped with a biooorganic substance jetting head used for biochip manufacture; devices equipped with a specimen jetting head as a precision pipette; textile printing devices; and microdispensers.

In the present invention, a liquid refers to any material capable of being jetted from a liquid consuming apparatus. Liquids such as those described in the preceding embodiments are typical examples of such liquids. The liquid could be a substance besides materials employed for printing of text and images, such as liquid crystals. In the present invention, the liquid is not limited to a liquid as one state of matter, and may also be a liquid as one state of matter incorporating a solid such as pigments or metal particles.

While the technology pertaining to the invention have been shown and described on the basis of the embodiments and variations, the embodiments of the invention described herein are merely intended to facilitate understanding of the invention, and implies no limitation thereof. Various modifications and improvements of the invention are possible without departing from the spirit and scope thereof as recited in the appended claims, and these will naturally be included as equivalents in the invention.

C. Variations

Variation 1: A liquid consuming system comprising a liquid consuming apparatus and a liquid container attachable to the liquid consuming apparatus, wherein
the liquid container includes:
   a liquid storage portion that stores a liquid;
   a liquid feed portion that connects with the liquid consuming apparatus and feeds the liquid to the liquid consuming apparatus when the liquid container is attached to the liquid consuming apparatus;
   a liquid sensing chamber defining portion having a liquid inlet communicating with the liquid storage portion and a liquid outlet communicating with the liquid feed portion and that defines a liquid sensing chamber that fluctuates in volume according to a differential between atmospheric pressure received from an outside and pressure received from an inside;
   a bias force member that exerts a bias force on the liquid sensing chamber from an inner side in a direction of expansion of volume of the liquid sensing chamber; and
   a sensor that senses a decline in volume of the liquid sensing chamber to a prescribed volume value,
wherein a pressure of liquid present in the liquid sensing chamber declines as a amount of liquid in the liquid storage portion becomes lower, and
the bias force is established such that if the amount of liquid in the liquid storage portion is equal to or greater than a prescribed amount, the liquid sensing chamber overcomes atmospheric pressure to assume a volume exceeding a prescribed volume value, whereas if the amount of liquid in the liquid storage portion is less than a prescribed amount, the liquid sensing chamber yields to atmospheric pressure to assume a volume equal to or less than a prescribed volume value,
the liquid consuming apparatus includes:
   a liquid intake portion connected to the liquid feed portion of the liquid container;
   a liquid consuming portion; and
   a diaphragm pump disposed between the liquid intake portion and the liquid consuming portion and adapted to deliver the liquid to the liquid consuming portion via the liquid intake portion through application of external force in a direction of expansion of volume thereof from a previous state of having been urged in the direction of reduction of internal volume followed by subsequent release of the external force;
and wherein pressure acting on the liquid sensing chamber resulting from the external force is greater than pressure produced by the bias force of the bias force member.

Variation 2: The liquid consuming system in accordance with Variation 1, wherein
the liquid container further includes a check valve disposed between the liquid feed portion and the liquid outlet, and adapted to block backflow of the liquid from the liquid feed portion towards the liquid sensing chamber.

Variation 3: The liquid consuming system in accordance with Variation 1, wherein
the liquid consuming apparatus further includes an on-off valve disposed between the diaphragm pump and the liquid intake portion.

Variation 4: A liquid consuming apparatus comprising:
a liquid consuming apparatus unit; and
a liquid container attached to the liquid consuming apparatus unit;
wherein the liquid container includes:
   a liquid storage portion that stores a liquid for feeding to the liquid consuming apparatus unit and composed at least in part of a flexible member;
   a liquid feed port connected to the liquid consuming apparatus unit and adapted to feed liquid stored in the liquid storage portion to the liquid consuming apparatus unit; and
   a liquid sensing device adapted to sense the remaining amount of liquid inside the liquid storage portion,
wherein the liquid sensing device includes:
   a liquid sensing chamber having a liquid inlet that communicates with the liquid storage portion and a liquid outlet that communicates with the liquid feed port;
   a flexible portion defining one face of the liquid sensing chamber and adapted to deform in response to the amount of liquid inside the liquid sensing chamber;
   a displaceable member housed within the liquid sensing chamber and capable of displacement actuated by deformation of flexible portion;
   sensing means adapted to sense displacement of the displaceable member to a prescribed location; and
   a bias force member adapted to urge the flexible portion in the direction of expansion of volume of the liquid sensing chamber,
wherein the liquid consuming apparatus unit includes:
   a liquid intake portion connected to the liquid feed port of the liquid container;
   a liquid consuming portion;
   a diaphragm pump disposed between the liquid intake portion and the liquid consuming portion for the purpose of feeding liquid from the liquid intake portion to the liquid consuming portion and adapted to deliver liquid through application of external force in the direction of expansion of volume thereof from a previous state of having been urged in the direction of reduced volume followed by subsequent release of the external force; and
   a check valve disposed between the diaphragm pump and the liquid intake portion and adapted to block backflow of liquid from the diaphragm pump towards the liquid intake portion,
and wherein pressure acting on the liquid sensing chamber resulting from external force applied in the direction of expansion of volume of the diaphragm pump will be greater than pressure applied to the liquid sensing chamber resulting from biasing force of the bias force member.

Variation 5: A liquid consuming apparatus comprising:
a liquid consuming apparatus unit; and
a liquid container attached to the liquid consuming apparatus unit;
wherein the liquid container includes:
   a liquid storage portion adapted to store a liquid for feeding to the liquid consuming apparatus unit and composed at least in part of a flexible member;
   a liquid feed port connected to the liquid consuming apparatus unit and adapted to feed liquid stored in the liquid storage portion to the liquid consuming apparatus unit; and
   a liquid sensing device adapted to sense the remaining amount of liquid inside the liquid storage portion,
wherein the liquid sensing device includes:
   a liquid sensing chamber having a liquid inlet that communicates with the liquid storage portion and a liquid outlet that communicates with the liquid feed port;
   a flexible portion defining one face of the liquid sensing chamber and adapted to deform in response to the amount of liquid inside the liquid sensing chamber;
   a displaceable member housed within the liquid sensing chamber and capable of displacement actuated by deformation of flexible portion;
   sensing means adapted to sense displacement of the displaceable member to a prescribed location; and
   a bias force member adapted to urge the flexible portion in the direction of expansion of volume of the liquid sensing chamber,
wherein the liquid container further includes a check valve disposed between the liquid feed port and the liquid outlet provided to the liquid sensing chamber and adapted to block backflow of liquid from the liquid feed port towards the liquid sensing chamber,
wherein the liquid consuming apparatus unit includes:
   a liquid intake portion connected to the liquid feed port of the liquid container;
   a liquid consuming portion; and
   a diaphragm pump disposed between the liquid intake portion and the liquid consuming portion for the purpose of feeding liquid from the liquid intake portion to the liquid consuming portion and adapted to deliver liquid through application of external force in the direction of expansion of volume thereof from a previous state of having been urged in the direction of reduced volume followed by subsequent release of the external force,
and wherein pressure acting on the liquid sensing chamber resulting from external force applied in the direction of expansion of volume of the diaphragm pump will be greater than pressure applied to the liquid sensing chamber resulting from biasing force of the bias force member.

Variation 6: The liquid consuming apparatus in accordance with Variation 4 or 5, wherein
an on-off valve is disposed on the liquid flow channel connecting the diaphragm pump and the liquid intake portion.

What is claimed is:

1. A liquid container attachable to a liquid consuming apparatus, the liquid container comprising:
a liquid storage portion that stores a liquid;
a liquid feed portion that connects with the liquid consuming apparatus and feeds the liquid to the liquid consuming apparatus when the liquid container is attached to the liquid consuming apparatus;
a liquid sensing chamber defining portion having a liquid inlet communicating with the liquid storage portion and a liquid outlet communicating with the liquid feed portion and that defines a liquid sensing chamber that fluctuates in volume according to a differential between external atmospheric pressure and internal pressure;
a bias force member that exerts a bias force on the liquid sensing chamber from an inner side in a direction of expansion of volume of the liquid sensing chamber; and
a sensor that senses if a volume of the liquid sensing chamber is reduced to a prescribed volume value,
wherein a pressure of liquid present in the liquid sensing chamber declines as an amount of liquid in the liquid storage portion becomes lower; and
the bias force is established such that if the amount of liquid in the liquid storage portion is equal to or greater than a prescribed amount, the liquid sensing chamber overcomes the atmospheric pressure to assume a volume exceeding the prescribed volume value, whereas if the amount of liquid in the liquid storage portion is less than the prescribed amount, the liquid sensing chamber yields to the atmospheric pressure to assume a volume equal to or less than the prescribed volume value.

2. The liquid container in accordance with claim 1, wherein
the liquid sensing chamber defining portion includes:
an open chamber portion having the liquid inlet, the liquid outlet, and an opening; and
a flexible portion that is formed of flexible material capable of deformation in response to a differential between the atmospheric pressure and the internal pressure and that covers the opening to define the liquid sensing chamber in association with the open chamber portion.

3. The liquid container in accordance with claim 2 further comprising:
a displaceable member housed within the liquid sensing chamber and capable of displacement due to deformation of the flexible portion;
wherein the sensor senses if volume of the liquid sensing chamber has dropped to the prescribed volume value by sensing if the displaceable member is displaced to a prescribed location; and
the bias force member biases the displaceable member in a direction away from the prescribed location.

4. The liquid container in accordance with claim 2, wherein
the bias force member is a spring disposed between the displaceable member and an opposing face situated in opposition to the flexible portion in the open chamber portion; and
the spring is not bonded to the opposing face and the displaceable member, but disposed in abutment with the opposing face and the displaceable member.

5. The liquid container in accordance with claim 1, wherein
the liquid storage portion is flexible at least in part, whereby the pressure of liquid present in the liquid sensing chamber declines as the amount of liquid in the liquid storage potion becomes lower.

6. The liquid container in accordance with claim 1 further comprising a check valve disposed between the liquid feed portion and the liquid outlet, and adapted to block backflow of the liquid from the liquid feed portion towards the liquid sensing chamber.

7. The liquid container in accordance with claim 1, wherein
the bias force is established such that if the amount of liquid in the liquid storage portion is less than a prescribed value and the liquid is flowing from the liquid storage portion into the liquid consuming apparatus, the liquid sensing chamber yields to the atmospheric pressure to assume a volume equal to or less than the prescribed volume value; and
the sensing by the sensor is executed while the liquid is flowing in the liquid storage portion.

8. The liquid container in accordance with claim 1, wherein
the bias force is established such that if the amount of liquid in the liquid storage portion is less than a prescribed value, then regardless of whether there is flow of liquid in the liquid storage portion, the liquid sensing chamber yields to the atmospheric pressure to assume volume equal to or less than the prescribed volume value; and
the sensing by the sensor is executed while the liquid is not flowing in the liquid storage portion.

9. A liquid container comprising:
a liquid storage portion that stores a liquid for feeding to a liquid consuming apparatus unit and composed at least in part of a flexible member;
a liquid feed port connected to the liquid consuming apparatus unit and adapted to feed liquid stored in the liquid storage portion to the liquid consuming apparatus unit; and
a liquid sensing device adapted to sense the remaining amount of liquid inside the liquid storage portion;
wherein the liquid sensing device includes:
a liquid sensing chamber having a liquid inlet that communicates with the liquid storage portion and a liquid outlet that communicates with the liquid feed port;
a flexible portion defining one face of the liquid sensing chamber and adapted to deform in response to the amount of liquid inside the liquid sensing chamber;
a displaceable member housed within the liquid sensing chamber and capable of displacement actuated by deformation of flexible portion;
sensing means adapted to sense displacement of the displaceable member to a prescribed location; and
a bias force member adapted to urge the displaceable member in a direction away from the prescribed location;
and wherein the liquid container satisfies the relationship Pf<Ps<Pe where Ps denotes pressure arising through biasing force biasing the displaceable member in a direction away from the prescribed location by the bias force member; Pf denotes the absolute value of negative pressure arising inside the liquid sensing chamber when liquid equal to or greater than a prescribed amount is present in the liquid storage portion; and Pe denotes the absolute value of negative pressure arising inside the liquid sensing chamber when the amount of liquid in the liquid storage portion is less than the prescribed amount.

10. A liquid container comprising:
a liquid storage portion that stores a liquid for feeding to a liquid consuming apparatus unit and composed at least in part of a flexible member;
a liquid feed port connected to the liquid consuming apparatus unit and adapted to feed liquid stored in the liquid storage portion to the liquid consuming apparatus unit; and
a liquid sensing device that senses a remaining amount of liquid inside the liquid storage portion,
wherein the liquid sensing device includes:
a liquid sensing chamber having a liquid inlet that communicates with the liquid storage portion and a liquid outlet that communicates with the liquid feed port;
a flexible portion defining one face of the liquid sensing chamber and adapted to deform in response to the amount of liquid inside the liquid sensing chamber;
a displaceable member housed within the liquid sensing chamber and capable of displacement actuated by deformation of flexible portion;
sensing means adapted to sense displacement of the displaceable member to a prescribed location; and
a bias force member adapted to urge the displaceable member in a direction away from the prescribed location;
and wherein a check valve adapted to block backflow of liquid from the liquid feed port towards the liquid sensing chamber is disposed between the liquid feed port and the liquid outlet from the liquid sensing chamber.

11. The liquid container according to claim 9, wherein
the bias force member is composed of a spring interposed between the displaceable member and the liquid sensing chamber, between a first face of the liquid sensing chamber and the face opposing the first face; and the displaceable member and the first face of the liquid sensing chamber are disposed in abutment without being attached.

12. A liquid consuming apparatus comprising:
a liquid intake portion connected to the liquid feed port of the liquid container in accordance with claim 2;
a liquid consuming portion; and
a diaphragm pump disposed between the liquid intake portion and the liquid consuming portion for the purpose of feeding liquid from the liquid intake portion to the liquid consuming portion and adapted to deliver liquid through application of external force in the direction of expansion of volume thereof from a previous state of having been urged in the direction of reduced volume followed by subsequent release of the external force;
wherein pressure acting on the liquid sensing chamber resulting from external force applied in the direction of expansion of volume of the diaphragm pump will be greater than pressure applied to the liquid sensing chamber resulting from biasing force of the bias force member which urges the flexible portion of the liquid sensing chamber.
